(19) United States
(12) Patent Application Publication
(10) Pub. No.: US 2006/0156554 A1
(43) Pub. Date: Jul. 20, 2006

(54) Positioning structure for retractable tube assembly

(76) Inventor: Thomas Lin, Wuci Township (TW)

Correspondence Address: BROWDY AND NEIMARK, P.L.L.C.;624 NINTH STREET, NW, SUITE 300, WASHINGTON, DC, 20001-5303, US

(21) Appl. No.: 11/084,026

(22) Filed: Mar. 21, 2005

(30) Foreign Application Priority Data
Jan. 17, 2005 (TW) 94200862

(51) Int. Cl. B26B 13/00

(52) U.S. Cl. 30/341; 30/296.1; 30/249

(57) ABSTRACT

A positioning structure for a retractable tube assembly having a retractable tube set, which has two semicircle recesses formed in a bottom wall thereof, and a rotary knob, which has a receiving hole formed in a top wall thereof, for locking the rotary knob to the retractable tube includes a positioning member that is movably mounted in the receiving hole of the rotary knob and has a bottom hole, and a spring member disposed between the bottom hole of the positioning member and the receiving hole of the rotary knob for pushing the positioning member into one semicircle recess to further lock the rotary knob to the retractable tube set.

### BACKGROUND OF THE INVENTION

1. Field of the Invention

The present invention relates to a retractable tube assembly and more particularly, to a positioning structure for a retractable tube assembly.

2. Description of the Related Art

A conventional retractable tube assembly is known comprising a retractable tube set and a rotary bottom block pivotally coupled to the retractable tube set for controlling the position of a tightening up member to lock or unlock the retractable tube set. The rotary bottom block has a hole accommodating a positioning member and a spring member. The positioning member has a rod onto which the spring member is sleeved. The spring member imparts an outward pressure to the positioning member to force the positioning member against the bottom wall of the retractable tube set so that the positioning member can be moved in and out of at least one recess in the bottom wall of the retractable tube set to lock or unlock the retractable tube assembly.

According to the aforesaid design, the spring member is sleeved onto the rod of the positioning member, and the spring force of the spring member is directly acted upon the bottom side of the positioning member. During operation, the positioning member may be tilted with the spring member and stuck in between the bottom wall of the retractable tube set and the top wall of the rotary bottom block, resulting in failure of the mechanism. Further, when rotating the rotary bottom block between the locking position and the unlocking position, a concentration of stress may be produced in the hole of the rotary bottom block, causing damage to the structure of the hole of the rotary bottom block. Damage of the structure of the hole of the rotary bottom block causes a positioning problem of the rotary bottom block in the retractable tube set.

### SUMMARY OF THE INVENTION

The present invention has been accomplished under the circumstances in view. It is one objective of the present invention to provide a positioning structure for a retractable tube assembly, which is easy to operate and durable in use.

To achieve this objective of the present invention, the positioning structure for a retractable tube assembly having a retractable tube set and a rotary knob for locking the rotary knob to the retractable tube comprises a positioning member and a spring member. The retractable tube set has at least one recess in a bottom wall thereof. The rotary knob has a receiving hole and is pivotally coupled to the bottom wall of the retractable tube set and rotatable relative to the retractable tube set to aim the receiving hole at the recess. The positioning member is axially movably mounted in the receiving hole of the rotary knob, having a bottom hole. The spring member is disposed between the bottom hole of the positioning member and the receiving hole of the rotary knob for pushing the positioning member into the recess to further lock the rotary knob to the retractable tube set.

### BRIEF DESCRIPTION OF THE DRAWINGS

FIG. 1 is a front view of a first preferred embodiment of the present invention, showing the positioning member stopped at one semicircle recess.

FIG. 2 is an exploded view of the first preferred embodiment of the present invention.

FIG. 3 is a sectional view taken in an enlarged scale along line 3-3 of FIG. 1.

FIG. 4 is similar to FIG. 3 but showing the rotary knob biased relative to the tube set.

FIG. 5 is a front view of the first preferred embodiment of the present invention, showing the positioning member stopped at the bottom wall of the grip.

FIG. 6 is a schematic drawing showing an application example of the first preferred embodiment of the present invention.

FIG. 7 is a sectional view of a positioning member and a spring member according to a second preferred embodiment of the present invention.

FIG. 8 is a sectional view of a positioning member and a spring member according to a third preferred embodiment of the present invention.

FIG. 9 is a front view of a fourth embodiment of the present invention.

### DETAILED DESCRIPTION OF THE INVENTION

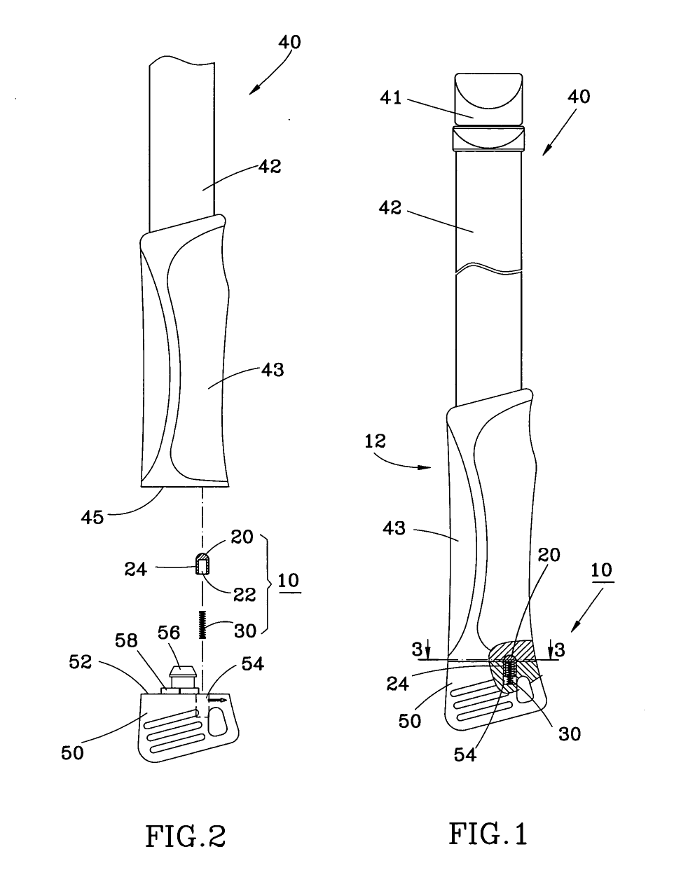

Referring to FIGS. 1-4, a positioning structure 10 in accordance with the first preferred embodiment of the present invention is shown installed in a retractable tube assembly 12. The retractable tube assembly 12 comprises a tube set 40 and a rotary knob 50. The positioning structure 10 comprises a positioning member 20 and a spring. member 30.

The tube set 40 comprises an inner tube 41, and an outer tube 42 sleeved onto the inner tube 41 and axially movable along the inner tube 41. The outer tube 42 has the bottom end thereof mounted with a grip 43. The inner tube 41 has the bottom end thereof mounted with locating means (not shown) for controlling positioning of the outer tube 42 relative to the inner tube 41 so as to further change the length of the tube set 40. The grip 43 has a sector groove 46 and two semicircle recesses 48 in the bottom wall 45 thereof.

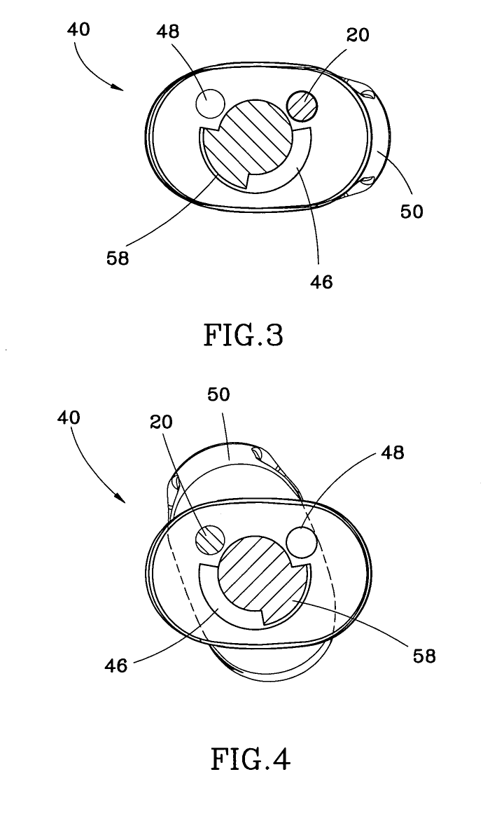

The rotary knob 50 has a top plane 52, a receiving hole 54 in the top plane 52, and a tubular split retaining bolt 56 upwardly extending from the center of the top plane 52. The tubular split retaining bolt 56 is pivotally coupled to the bottom wall 45 of the grip 43 and fixedly connected to the locating means at the inner tube 41, having a protruding portion 58 received in the sector groove 46 of the rotary knob 50. Rotating the rotary knob 50 causes rotation of the locating means at the inner tube 41 relative to the outer tube 42 to lock the outer tube 42 to the inner tube 41 or to unlock the outer tube 42 from the inner tube 41. As shown in FIGS. 3 and 4, the sector groove 46 accommodates the protruding portion 58, limiting the turning angle of the rotary knob 50 relative to the grip 43 between two positions where the receiving hole 54 is aimed at one of the semicircle recesses 48 of the grip 43.

The positioning member 20 is a cylindrical member having a rounded top end at the top side of the cylindrical body 24 thereof and a cylindrical bottom hole 22 in the bottom end of the cylindrical body 24. The positioning member 20 is inserted into the receiving hole 54 of the rotary knob 50 and axially movable in the receiving hole 54.

The spring member 30 is a compression spring, having one end stopped at the inside wall of the receiving hole 54 of the rotary knob 50 and the other end stopped at the inside wall of the cylindrical bottom hole 22 of the positioning member 20. The spring member 30 imparts a pressure to the positioning member 20 toward the tube set 40. When turning the rotary knob 50, the positioning member 20 is movably stopped the top side thereof at the bottom wall 45 of the grip 43, and can be alternatively shifted between the semicircle recesses 48 in the bottom wall 45 of the grip 43 to lock the rotary knob 50 to the tube set 40.

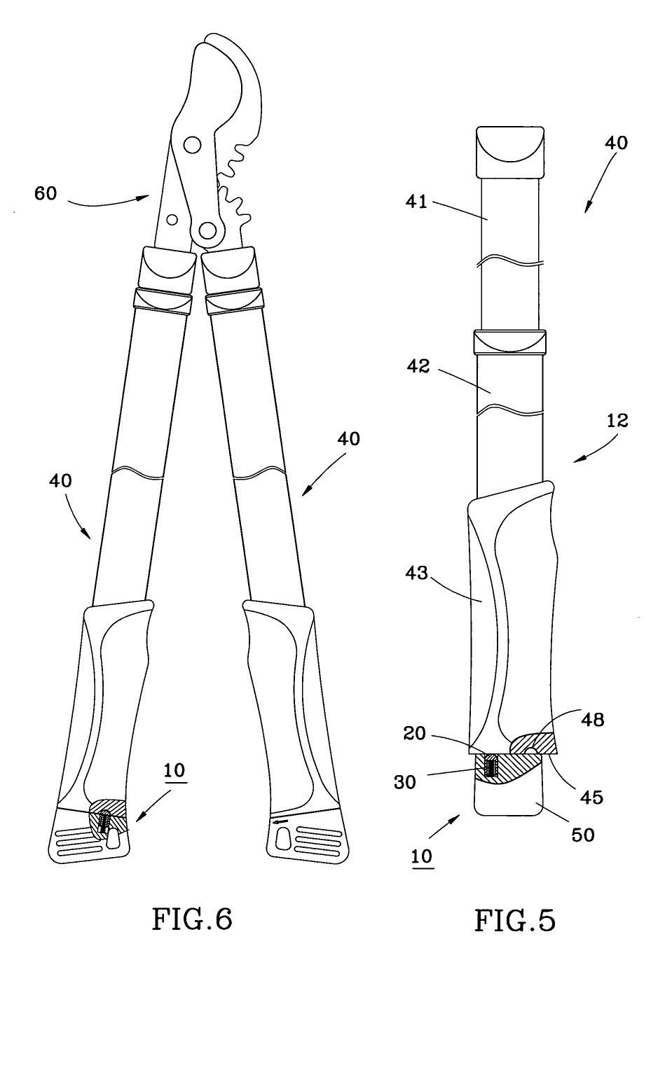

Referring to FIGS. 1 and 5, when turning the rotary knob 50 relative to the tube set 40, the top side of the positioning member 20 is moved along the bottom wall 45 of the grip 43 between the semicircle recesses 48, causing the positioning member 20 to be moved up and down in the receiving hole 54 of the rotary knob 50. Because the spring member 30 has one end fastened to the inside of the positioning member 20, the positioning member 20 does not tilt when forced by the spring member 20 against the bottom wall 45 of the grip 43. Therefore, the positioning member 20 can be moved axially in the receiving hole 54 of the rotary knob 50 to compress or release the spring member 30. Because the periphery of the cylindrical body 24 of the positioning member 20 is disposed in contact with the periphery of the receiving hole 54 of the rotary knob 50, movement of the positioning member 20 in the receiving hole 54 does not causes a concentration of stress, preventing damage to the receiving hole 54.

FIG. 6 shows an application example of the present invention. According to this application example, the two handles of the hedge shears 60 are respectively formed of a retractable tube assembly 12. The user can conveniently adjust the length of the handles (retractable tube assemblies 12) of the hedge shears 60 subject to the desired cutting height.

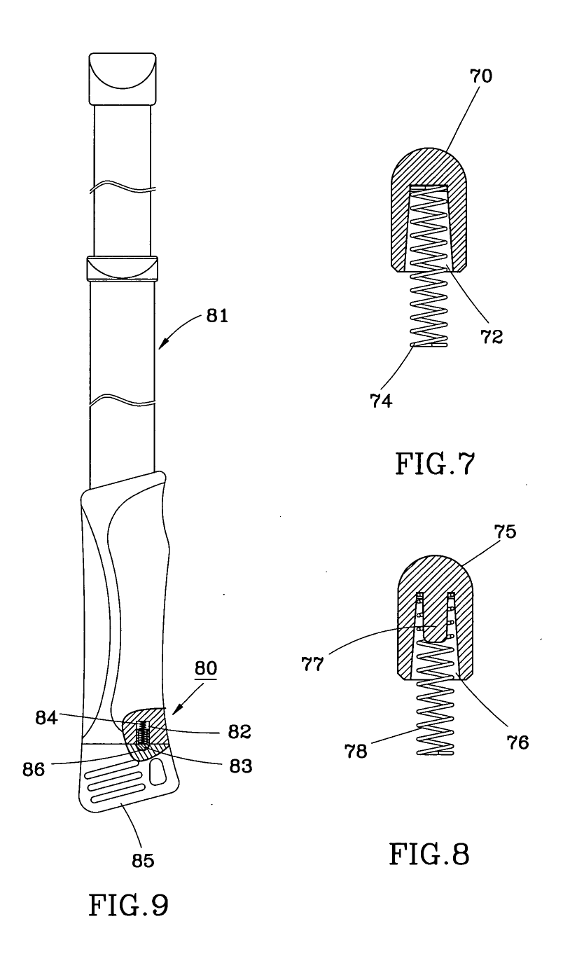

FIG. 7 is a sectional view of a part of the second preferred embodiment of the present invention. According to this embodiment, the positioning member, referenced by 70, has a tapered bottom hole 72, which has a diameter made gradually increasing toward the bottom side of the positioning member 70. The diameter of the bottom side of the bottom hole 72 is approximately equal to the outer diameter of the spring member 74.

FIG. 8 is a sectional view of a part of the third preferred embodiment of the present invention. According to this embodiment, the positioning member, referenced by 75, has a tapered bottom hole 76 and a downwardly extending locating rod 77 suspending in the tapered bottom hole 76 for holding one end of the spring member 78 in the tapered bottom hole 76.

FIG. 9 illustrates a positioning structure 80 according to the fourth preferred embodiment of the present invention. This embodiment is substantially similar to the aforesaid first preferred embodiment. According to this embodiment, the tube set 81 has a bottom receiving hole 82. The positioning structure 80 comprises a positioning member 83 and a spring member 84. The rotary knob 85 has at least one semicircle recess 86 for receiving the positioning member 83. This embodiment achieves the same effect as the aforesaid first embodiment.

What is claimed is:

1. A positioning structure for a retractable tube assembly having a retractable tube set and a rotary knob for locking said rotary knob to said retractable tube set, said positioning structure comprising a positioning member and a spring member;
wherein said retractable tube set has at least one recess;
wherein said rotary knob has a receiving hole and is pivotally coupled to said retractable tube set and rotatable relative to said retractable tube set to aim said receiving hole at said recess;
wherein said positioning member is movably mounted in said receiving hole of said rotary knob and has a bottom hole;
wherein said spring member is disposed between the bottom hole of said positioning member and the receiving hole of said rotary knob for pushing said positioning member into said recess to further lock said rotary knob to said retractable tube set.

2. The positioning structure as claimed in claim 1, wherein the bottom hole of said positioning member is a cylindrical hole.

3. The positioning structure as claimed in claim 1, wherein the bottom hole of said positioning member is a tapered hole.

4. The positioning structure as claimed in claim 1, wherein said positioning member has a locating rod downwardly extending in the bottom hole thereof and said spring member has an end sleeved onto said locating rod.

5. A positioning structure for a retractable tube assembly having a retractable tube set and a rotary knob for locking said rotary knob to said retractable tube set, said positioning structure comprising a positioning member and a spring member;
wherein said retractable tube set has a receiving hole;
wherein said rotary knob has at least one recess and is pivotally coupled to said retractable tube set and rotatable relative to said retractable tube set to aim said recess at said receiving hole;
wherein said positioning member is movably mounted in said receiving hole and has a bottom hole;
wherein said spring member is disposed between the bottom hole of said positioning member and the receiving hole of said retractable tube set for pushing said positioning member into said recess to further lock said rotary knob to said retractable tube set.

6. The positioning structure as claimed in claim 5, wherein the bottom hole of said positioning member is a cylindrical hole.

7. The positioning structure as claimed in claim 5, wherein the bottom hole of said positioning member is a tapered hole.

8. The positioning structure as claimed in claim 5, wherein said positioning member has a locating rod downwardly extending in the bottom hole thereof and said spring member has an end sleeved onto said locating rod.

9. A pair of hedge shears comprising at least one retractable tube assembly, said retractable tube assembly comprising:
a retractable tube set having at least one recess;
a rotary knob pivotally coupled to said retractable tube set, said rotary knob having a receiving hole, said rotary knob being rotatable relative to said retractable tube set to aim said receiving hole at said recess;
a positioning member movably mounted in said receiving hole of said rotary knob, said positioning member having a bottom hole; and
a spring member disposed between the bottom hole of said positioning member and the receiving hole of said rotary knob for pushing said positioning member into said recess to further lock said rotary knob to said retractable tube set.

10. A pair of hedge shears comprising at least one retractable tube assembly, said retractable tube assembly comprising:
a retractable tube set having a receiving hole;
a rotary knob pivotally coupled to said retractable tube set, said rotary knob having at least one recess, said rotary knob being rotatable relative to said retractable tube set to aim said recess at said receiving hole;
a positioning member movably mounted in said receiving hole, said positioning member having a bottom hole; and
a spring member disposed between the bottom hole of said positioning member and the receiving hole of said retractable tube set for pushing said positioning member into said recess to further lock said rotary knob to said retractable tube set.
